(19) United States
(12) Patent Application Publication
(10) Pub. No.: US 2013/0077343 A1
(43) Pub. Date: Mar. 28, 2013

(54) BACKLIGHT UNIT AND DISPLAY APPARATUS HAVING THE SAME

(71) Applicants: Yongil KIM, Suwon-si (KR); Sung Won BAE, Seongnam-si (KR); Suksun LEE, Yongin-si (KR); Jaehwan CHUN, Suwon-si (KR); Jaechang CHOI, Yongin-si (KR)

(72) Inventors: Yongil KIM, Suwon-si (KR); Sung Won BAE, Seongnam-si (KR); Suksun LEE, Yongin-si (KR); Jaehwan CHUN, Suwon-si (KR); Jaechang CHOI, Yongin-si (KR)

(73) Assignee: SAMSUNG DISPLAY CO., LTD., Yongin-City (KR)

(21) Appl. No.: 13/570,445

(22) Filed: Aug. 9, 2012

(30) Foreign Application Priority Data
Sep. 28, 2011 (KR) 10-2011-0098495

(51) Int. Cl. F21V 15/04; G09F 13/18; F21V 8/00

(52) U.S. Cl. 362/602; 362/611

(57) ABSTRACT

A backlight unit includes a light source unit emitting a light, a light guide plate guiding the light, and a lower cover accommodating the light guide plate and the light source unit, and a deformation preventing member disposed at two first corners among four corners of the lower cover in a plan view, to prevent the light guide plate from being deformed. The two first corners are spaced apart from the light source unit and remaining two second corners of the four corners are adjacent to the light source unit.

This application claims priority to Korean Patent Application No. 10-2011-0098495 filed on Sep. 28, 2011, and all the benefits accruing therefrom under 35 U.S.C. §119, the contents of which are herein incorporated by reference in its entirety.

### BACKGROUND OF THE INVENTION

1. Field of the Invention

The invention relates to a backlight unit and a display apparatus having the same. More particularly, the invention relates to a backlight unit capable of preventing a light guide plate from being deformed and a display apparatus having the backlight unit.

2. Description of the Related Art

In general, since a display apparatus including a display panel as a liquid crystal display panel or an electrophoretic display panel is not self-emissive, the display apparatus requires a separate light source, e.g., a backlight unit, to provide light thereto.

The backlight unit includes a light source emitting the light and a light guide plate guiding the light emitted from the light source to the display panel.

However, the light guide plate is expanded due to heat generated from the light source, thereby causing deformation of the light guide plate. In addition, when the light guide plate is expanded, the light source is damaged by pressure applied to the light source.

### BRIEF SUMMARY OF THE INVENTION

Exemplary embodiments of the invention provide a backlight unit capable of preventing a light source from being damaged and a light guide plate from being deformed.

Exemplary embodiments of the invention provide a display apparatus including the backlight unit.

According to the exemplary embodiments, a backlight unit includes a light source unit emitting a light, a light guide plate guiding the light, a lower cover accommodating the light guide plate and the light source unit, and a deformation preventing member disposed at two first corners among four corners of the lower cover in a plan view, to prevent the light guide plate from being deformed. The two first corners are spaced apart from the light source unit and remaining two second corners of the four corners are adjacent to the light source unit.

The lower cover includes an engaging hole extended therethrough, and the deformation preventing member includes a mounting portion on which the light guide plate is mounted, sidewalls extended from two sides thereof making contact with the lower cover, and a catching jaw protruded from at least one of the sidewalls and inserted into the engaging hole of the lower cover.

The lower cover includes a penetrating hole extended therethrough, and the deformation preventing member further includes a protrusion protruded from a lower portion of the mounting portion and coupled with the penetrating hole of the lower cover.

The backlight unit further includes an expansion preventing member disposed at the remaining two second corners of the lower cover, which are respectively adjacent to both ends of the light source unit, to prevent the light guide plate from being expanded and from making contact with the light source unit.

According to the exemplary embodiments, a display apparatus includes a backlight unit including a light source unit emitting a light and a light guide plate guiding the light, a display panel receiving the light from the backlight unit to display an image, a lower cover accommodating the backlight unit and the display panel, and a deformation preventing member disposed at two first corners among four corners of the lower cover in a plan view, to prevent the light guide plate from being deformed. The two first corners are spaced apart from the light source unit and remaining two second corners of the four corners are adjacent to the light source unit.

According to the above, the backlight unit may reduce or effectively prevent the light guide plate from being expanded and deformed, thereby preventing the light source from being damaged.

### BRIEF DESCRIPTION OF THE DRAWINGS

The above and other advantages of the invention will become readily apparent by reference to the following detailed description when considered in conjunction with the accompanying drawings wherein:

FIG. 1 is an exploded perspective view showing an exemplary embodiment of a display apparatus according to the invention;

FIG. 2 is a plan view showing a lower cover, a light guide plate, a light source unit, an expansion preventing member, and a deformation preventing member shown in FIG. 1;

FIG. 3 is a cross-sectional view showing the display apparatus taken along line I-I′ shown in FIG. 2;

FIG. 4A is a partially enlarged view of the display apparatus showing an area in which an expansion preventing member is disposed of FIG. 1;

FIG. 4B is a perspective view showing an exemplary embodiment of an expansion preventing member;

FIG. 5A is a partially enlarged view showing an area of the display apparatus in which a deformation preventing member is disposed of FIG. 1;

FIG. 5B is a perspective view showing an exemplary embodiment of a deformation preventing member;

FIG. 6 is a plan view showing another exemplary embodiment of a display apparatus according to the invention; and

FIG. 7 is a plan view showing another exemplary embodiment of a display apparatus according to the invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” or “under” other elements or features would then be oriented “above” the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be explained in detail with reference to the accompanying drawings.

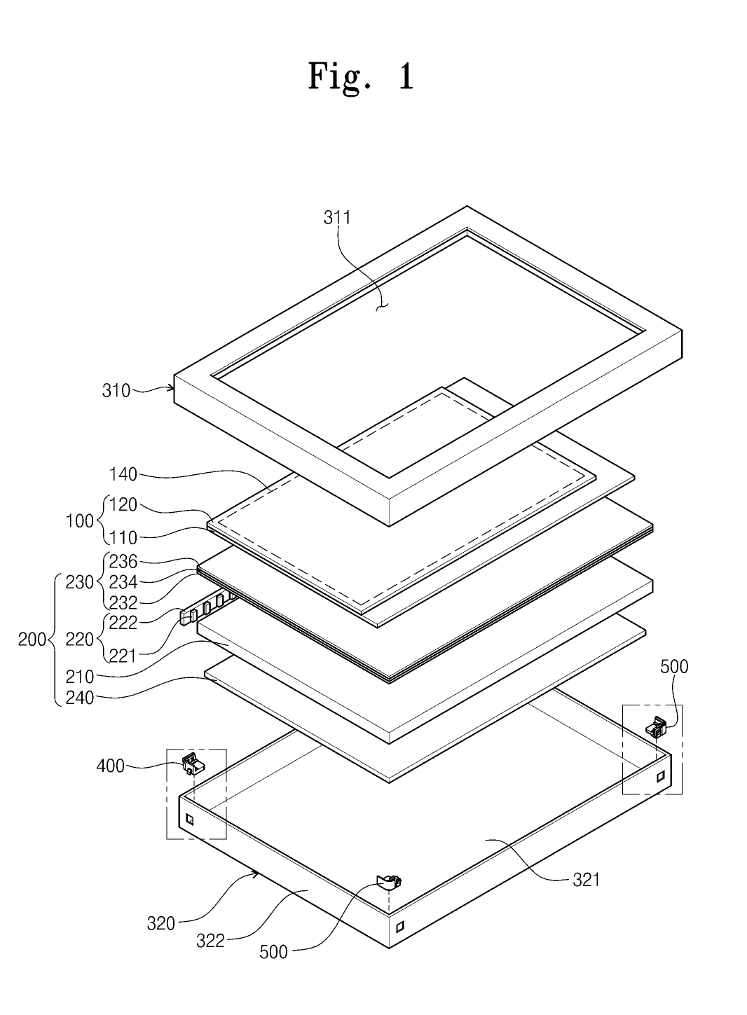

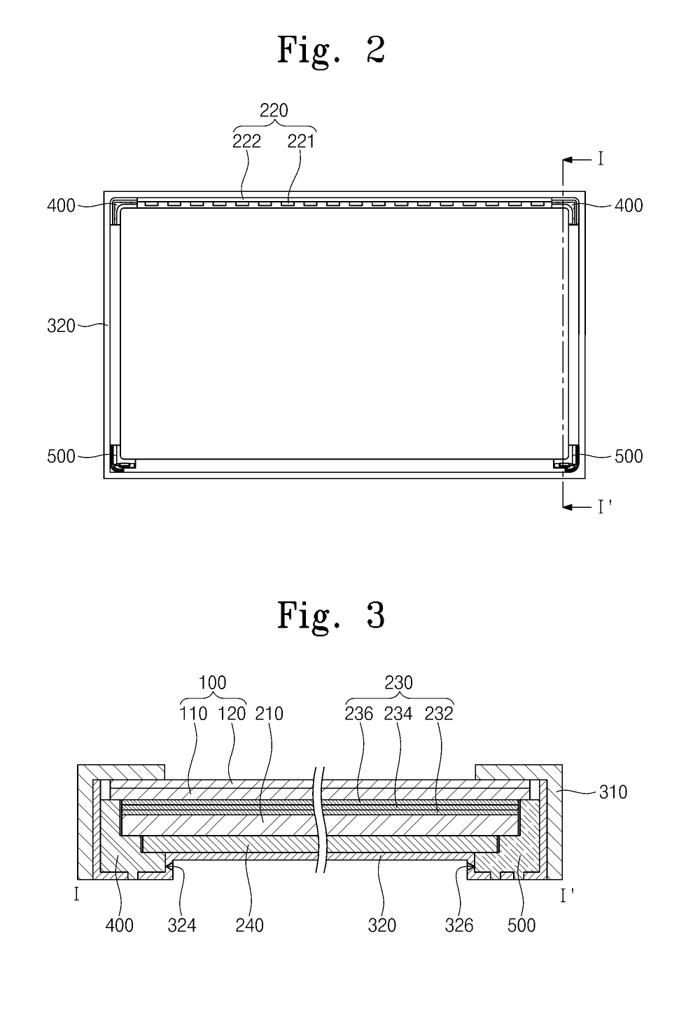

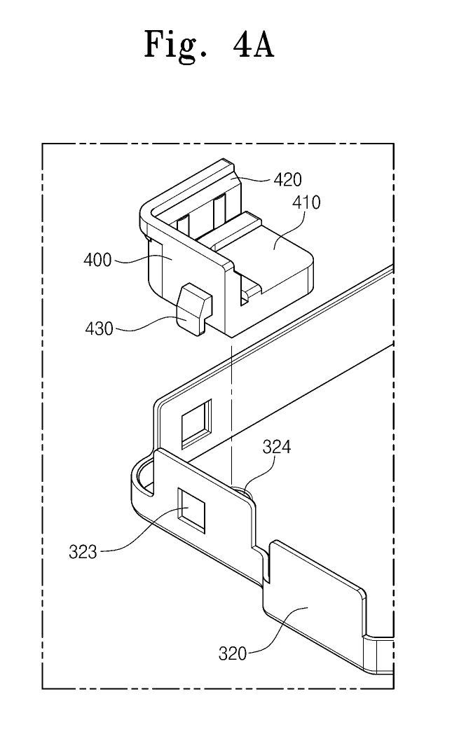

FIG. 1 is an exploded perspective view showing an exemplary embodiment of a display apparatus according to the invention, FIG. 2 is a plan view showing a lower cover, a light guide plate, a light source unit, an expansion preventing member, and a deformation preventing member shown in FIG. 1, and FIG. 3 is a cross-sectional view showing the display apparatus taken along line I-I′ shown in FIG. 2.

Referring to FIGS. 1 to 3, a display apparatus includes a display panel 100, a backlight unit 200, an upper cover 310, a lower cover 320, an expansion preventing member 400, and a deformation preventing member 500.

The display panel 100 includes a display area 140 to display an image using light. The display panel 100 may be various display panels, such as a liquid crystal display panel, an electrophoretic display panel, etc. In the exemplary embodiment, the liquid crystal display panel will be described as the display panel 100.

In addition, the display panel 100 has a rectangular plate shape with a pair of long sides and a pair of short sides. The display panel 100 includes an array substrate 110, an opposite substrate 120 facing the array substrate 110, and a liquid crystal layer (not shown) interposed between the array substrate 110 and the opposite substrate 120.

The array substrate 110 includes a plurality of gate lines (not shown) extended in a first direction, and a plurality of data lines (not shown) extended in a second direction crossing the first direction and electrically insulated from the gate lines while crossing the gate lines. In addition, the array substrate 110 includes a plurality of pixels (not shown) arranged in a matrix form. Each pixel includes a thin film transistor (not shown) and a pixel electrode (not shown). The thin film transistor includes a gate electrode electrically connected to a corresponding gate line of the gate lines, a source electrode electrically connected to a corresponding data line of the data lines, and a drain electrode electrically connected to the pixel electrode. Accordingly, the thin film transistor switches a signal to control or drive a corresponding pixel of the pixels.

The opposite substrate 120 includes red, green, and blue color filters (not shown) on a surface thereof to display predetermined colors and a common electrode (not shown) disposed on the red, green, and blue color filters to face the pixel electrode. The red, green, and blue color filters may be formed through a thin film process. In the exemplary embodiment, the red, green, and blue color filters are disposed on the opposite substrate 120, but they should not be limited thereto or thereby. That is, the red, green, and blue color filters may be disposed on the array substrate 110 according to embodiments.

The liquid crystal layer includes liquid crystal molecules arranged in a specific direction according to voltages respectively applied to the pixel electrode and the common electrode. Thus, the liquid crystal layer controls a transmittance of the light from the backlight unit 200 and passing therethrough so as to allow the display panel 100 to display the image.

The backlight unit 200 is disposed under a lower surface of the array substrate 110 to provide the light to the display panel 100. In addition, the light provided to the display panel 100 exits from an upper surface of the opposite substrate 120. The backlight unit 200 includes a light guide plate 210 guiding the light to the display panel 100, a light source unit 220 emitting the light to the light guide plate 210, an optical member 230, and a reflective sheet 240.

The light guide plate 210 has a rectangular plate shape corresponding to the display panel 100 and includes a transparent material to refract the light. The light guide plate 210 may include a transparent polymer resin, such as polycarbonate, polymethyl methacrylate, etc. In addition, the light guide plate 210 is disposed under the display panel 100 to guide the light emitted from the light source unit 220 to the display panel 100. The light guide plate 210 is overlapped with at least the display area 140 of the display panel 100 when viewed in a plan view. The light guide plate 210 includes an upper surface, a lower surface facing the upper surface, and side surfaces connecting the upper surface and the lower surface. One of the side surfaces of the light guide plate 210 may be a light incident surface into which the light emitted from the light source unit 220 is incident and the upper surface of the light guide plate 210 may be a light exiting surface from which the light guided by the light guide plate 210 exits to the display panel 100.

The light source unit 220 includes at least one light source 221, and a circuit board 222 applying a source voltage to the light source 221. The light source 221 is mounted on the circuit board 222. The light source 221 may be a light emitting diode. In addition, a heat discharge member (not shown) may be disposed on a surface of the circuit board 222, which is opposite to the surface on which the light source 221 is mounted, to discharge the heat generated from the light source 221. The light source unit 220 is disposed adjacent to one of the side surfaces of the light guide plate 210 to provide the light to the light guide plate 210.

The optical member 230 is disposed between the light guide plate 210 and the display panel 100. The optical member 230 controls the light emitted from the light source unit 220 and exiting from the light guide plate 210. In addition, the optical member 230 includes a diffusion sheet 232, a prism sheet 234 and a protective sheet 236, which are sequentially stacked one above another.

The diffusion sheet 232 diffuses the light exiting from the light guide plate 210. The prism sheet 234 condenses the light diffused by the diffusion sheet 232 to allow the diffused light to travel in a direction substantially vertical to the display panel 100. Accordingly, the light exiting from the prism sheet 234 is vertically incident to the display panel 100. The protective sheet 236 is disposed on the prism sheet 234 to protect the prism sheet 234 from external impacts.

In the exemplary embodiment, the optical member 230 includes one of each of the diffusion sheet 232, the prism sheet 234 and the protective sheet 236, but it should not be limited thereto or thereby. That is, at least one of the diffusion sheet 232, the prism sheet 234 or the protective sheet 236 may be provided in a plural number, or one of the diffusion sheet 232, the prism sheet 234 or the protective sheet 236 may be omitted from the optical member 230.

The reflective sheet 240 is disposed under the light guide plate 210 to reflect the light leaked from the light guide plate 210 toward the display panel 100. The reflective sheet 240 includes a material that reflects the light. The reflective sheet 240 is disposed on the lower cover 320 to reflect the light emitted from the light source unit 220. As a result, an amount of the light provided to the display panel 100 may be enhanced by the reflective sheet 240.

The upper cover 310 is disposed on the display panel 100. The upper cover 310 includes a display window 311 which extends therethrough to expose the display area 140 of the display panel 100. The upper cover 310 includes an upper surface supporting and overlapping a front end portion of the display panel 100, and a plurality of upper cover side surfaces bent and extended downward from the upper surface. Since the display panel 100 has the rectangular plate shape, the upper cover 310 may include four upper cover side surfaces. The upper cover 310 is coupled with the lower cover 320 to support the front end portion of the display panel 100.

The lower cover 320 is disposed under the backlight unit 200. The lower cover 320 includes a bottom surface 321 corresponding to the shape of the display panel 100 and the backlight unit 200, and a plurality of lower cover side surfaces 322 bent and extended upward from the bottom surface 321. Since the display panel 100 has the rectangular plate shape, the lower cover 320 may include four lower cover side surfaces 322. The lower cover 320 provides a space accommodating the display panel 100 and the backlight unit 200 by the bottom surface 321 and the lower cover side surfaces 322. In addition, the lower cover 320 is coupled with the upper cover 310 to accommodate the display panel 100 and the backlight unit 200 therein and support the display panel 100 and the backlight unit 200.

The expansion preventing member 400 is disposed at two corners among four corners of the lower cover 320, which are adjacent to both of opposing ends of the light source unit 220, to reduce or effectively prevent the expansion of the light guide plate 210. The expansion preventing member 400 includes a relatively hard or non-elastic material to maintain its original shape even though the light guide plate 210 is expanded by the heat generated from the light source unit 220. Thus, the expansion preventing member 400 may reduce or effectively prevent the light guide plate 210 from being expanded toward the light source unit 220 and from making contact with the light source unit 220.

The deformation preventing member 500 is disposed at two corners among the four corners of the lower cover 320, at which the expansion preventing member 400 is not positioned, to reduce or effectively prevent the deformation of the light guide plate 210. The deformation preventing member 500 includes an elastic material such as silicon (Si). Accordingly, the deformation preventing member 500 may absorb the expansion of the light guide plate 210 when the light guide plate 210 is expanded due to the heat generated from the light source unit 220, thereby reducing or preventing the deformation of the light guide plate 210.

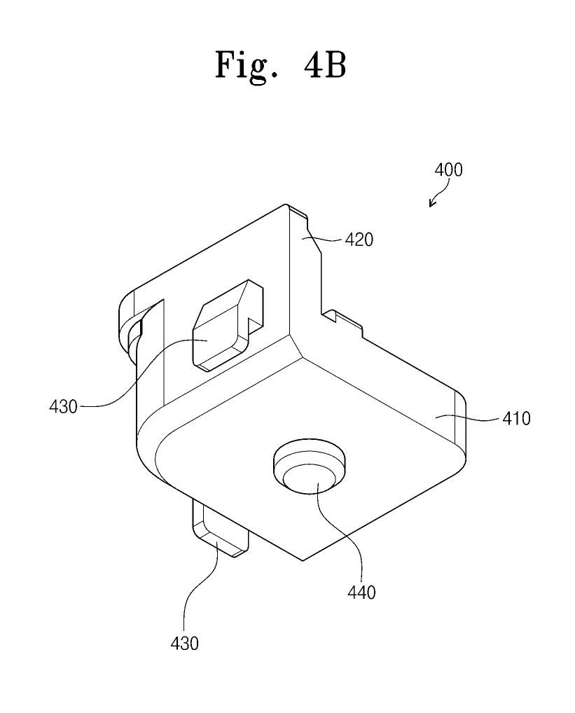

FIG. 4A is a partially enlarged view showing an area of the display apparatus in which an expansion preventing member is disposed of FIG. 1 and FIG. 4B is a perspective view showing an exemplary embodiment of an expansion preventing member.

Referring to FIGS. 4A and 4B, the expansion preventing member 400 includes a first mounting portion 410 on which the reflective sheet 240, the light guide plate 210, and the optical member 230 are mounted, first sidewalls 420 extended from two sides of the first mounting portion 410 and making contact with the lower cover 320, a first catching jaw 430 protruded from at least one of the first sidewalls 420 and coupled with the lower cover 320, and a first protrusion 440 protruded from the first mounting portion 410 and coupled with a first penetrating hole 324 extending through a thickness of the bottom surface 321 of the lower cover 320. The first sidewalls 420 may prevent the sheets from moving. In addition, the first catching jaw 430 is protruded from the first sidewalls 420 and bent downward to be inserted into a first engaging hole 323 of the lower cover 320. Thus, the first catching jaw 430 is inserted into the first engaging hole 323 and the first protrusion 440 is coupled with the first penetrating hole 324, thereby fixing the expansion preventing member 400 to the lower cover 320. The first engaging hole 323 and the first penetrating hole 324 are enclosed openings which respectively penetrate a side surface and the bottom surface 321 of the lower cover 320, such that the side surface and the bottom surface 321 solely define the enclosed openings.

The expansion preventing member 400 is disposed at the two corners among the four corners of the lower cover 320, which are adjacent to both opposing ends of the light source unit 220. In addition, since the expansion preventing member 400 includes the hard or non-elastic material, the expansion preventing member 400 may reduce or effectively prevent the light guide plate 210 from exerting influences to the light source 221 even though the light guide plate 210 is expanded due to the heat generated from the light source unit 220. Thus, the expansion preventing member 400 may reduce or effectively prevent the light source 221 from being damaged.

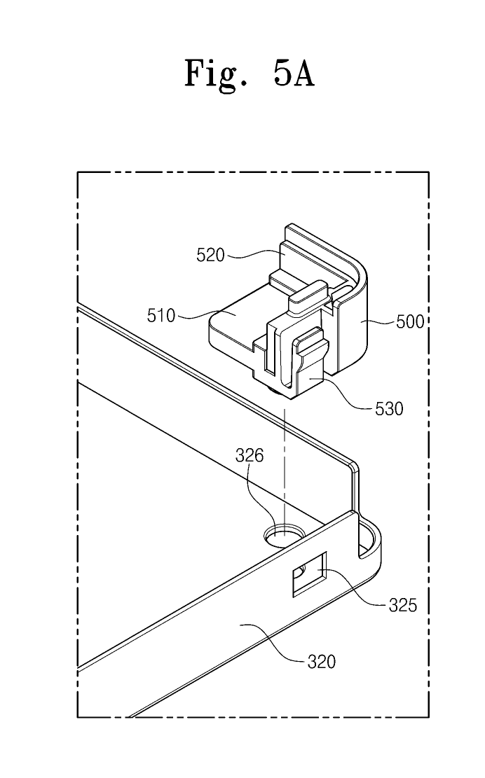

FIG. 5A is a partially enlarged view showing an area of the display apparatus in which a deformation preventing member is disposed of FIG. 1 and FIG. 5B is a perspective view showing an exemplary embodiment of a deformation preventing member.

Referring to FIGS. 5A and 5B, the deformation preventing member 500 includes a second mounting portion 510 on which the reflective sheet 240, the light guide plate 210 and the optical member 230 are mounted, second sidewalls 520 extended from two sides of the second mounting portion 510 making contact with the lower cover 320, a second catching jaw 530 protruded from at least one of the second sidewalls 520 and coupled with the lower cover 320, and a second protrusion 540 protruded from the second mounting portion 510 and coupled with a second penetrating hole 326 extending through a thickness of the bottom surface 321 of the lower cover 320. The second catching jaw 530 is protruded from the second sidewalls 520 and bent downward to be inserted into a second engaging hole 325 of the lower cover 320. Thus, the second catching jaw 530 is inserted into the second engaging hole 325 so as to fix the deformation preventing member 500 to the lower cover 320. The deformation preventing member 500 may include a plurality of second protrusions 540, and a plurality of second penetrating holes 326 into which the second protrusions 540 are inserted. The second engaging hole 325 and the second penetrating hole 326 are enclosed openings which respectively penetrate a side surface and the bottom surface 321 of the lower cover 320, such that the side surface and the bottom surface 321 solely define the enclosed openings.

The deformation preventing member 500 is disposed at the two corners among the four corners of the lower cover 320, at which the expansion preventing member 400 is not positioned.

In addition, since the deformation preventing member 500 includes the elastic material, the second sidewalls 520 are compressed corresponding to the deformation amount of the light guide plate 210 when the light guide plate 210 is expanded due to the heat generated from the light source unit 220 and returns to its original shape when the deformation of the light guide plate 210 is recovered. Accordingly, the deformation preventing member 500 may reduce or effectively prevent the light guide plate 210 from being deformed.

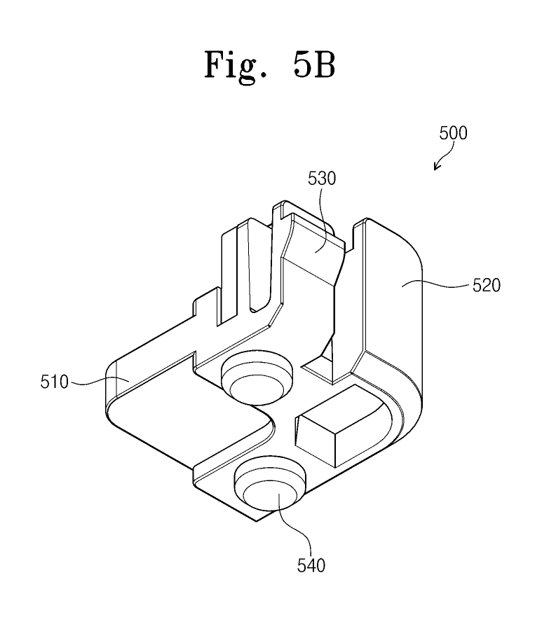

FIG. 6 is a plan view showing another exemplary embodiment of a display apparatus according to the invention. In FIG. 6, the same reference numerals denote the same elements in FIGS. 1 to 5, and thus detailed descriptions of the same elements will be omitted.

Referring to FIG. 6, the light guide plate 210 further includes a concave portion 211 which may be formed by removing a portion of two sides of the light guide plate 210, which are substantially perpendicular and adjacent to the light source unit 220, and the lower cover 320 further includes a protrusion 328 protruded from the bottom surface 321 thereof corresponding to the concave portion 211 and coupled with the concave portion 211. The expansion preventing member 400 as shown in FIGS. 4A and 4B is omitted from the display apparatus according to the exemplary embodiment.

The concave portion 211 is disposed spaced apart from the light source unit 220 by a distance equal to or smaller than about 1/10 of the distance between two sides of the light guide plate 210, which are substantially parallel to the light source unit 220.

When the light guide plate 210 is expanded due to the heat generated from the light source unit 220, the portion of the light guide plate 210 which is disposed between the concave portion 211 and the light source unit 220, is substantially not expanded, and the portion of the light guide plate 210 which is disposed between the concave portion 211 and the deformation preventing member 500, is mainly expanded.

Thus, although the light guide plate 210 is expanded due to the heat generated from the light source unit 220, the light guide plate 210 does not exert significantly influences on the light source unit 220. In addition, since the second sidewalls 520 are compressed by the deformation amount of the portion of the light guide plate 210 which is disposed between the concave portion 211 and the deformation preventing member 500, deformation of the light guide plate 210 may be reduced or effectively prevented.

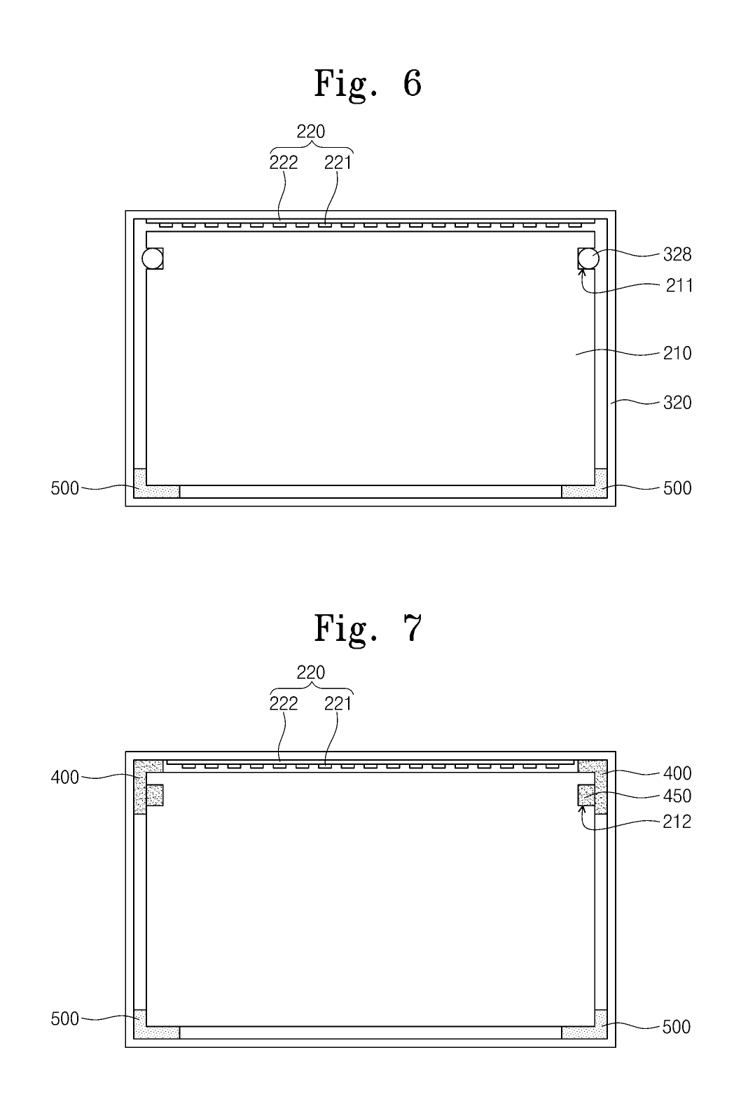

FIG. 7 is a plan view showing another exemplary embodiment of a display apparatus according to the invention. In FIG. 7, the same reference numerals denote the same elements in FIGS. 1 to 5, and thus detailed descriptions of the same elements will be omitted.

Referring to FIG. 7, the light guide plate 210 further includes a concave portion 212 which may be formed by removing a portion of two sides of the light guide plate 210, which are substantially perpendicular to the light source unit 220, and the expansion preventing member 400 further includes a protrusion 450 protruded from the first mounting portion 410 thereof corresponding to the concave portion 212 and coupled with the concave portion 212.

When the light guide plate 210 is expanded due to the heat generated from the light source unit 220, the portion of the light guide plate 210 which is disposed between the concave portion 212 and the deformation preventing member 500, is mainly expanded. When the light guide plate 210 is expanded due to the heat generated from the light source unit 220, the portion of the light guide plate 210 which is disposed between the concave portion 212 and the light source unit 220, is substantially not expanded.

Accordingly, although the light guide plate 210 is expanded due to the heat generated from the light source unit 220, the light guide plate 210 does not exert significantly influences on the light source unit 220. In addition, since the second sidewalls 520 are compressed by the deformation amount of the portion of the light guide plate 210 which is disposed between the concave portion 212 and the deformation preventing member 500, deformation of the light guide plate 210 may be reduced or effectively prevented.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A backlight unit comprising:
a light source unit which generates and emits a light;
a light guide plate which guides the light, the light source unit adjacent to a first side of the light guide plate;
a lower cover which accommodates the light guide plate and the light source unit therein, and comprises four corners in a plan view; and
a deformation preventing member at two first corners among the four corners of the lower cover, which are spaced apart from the light source unit,
wherein
remaining two second corners of the four corners of the lower cover are adjacent to the light source unit, and
the deformation preventing member restricts deformation of the light guide plate.

2. The backlight unit of claim 1, wherein the deformation preventing member comprises an elastic material.

3. The backlight unit of claim 2, wherein
the lower cover further comprises a bottom surface, a sidewall which extends from an edge of the bottom surface and an engaging hole which extends through the sidewall, and
the deformation preventing member comprises:
a mounting portion which overlaps a corner of the light guide plate;
sidewalls which extend from two sides of the mounting portion and contact the lower cover; and
a catching jaw which protrudes from at least one of the sidewalls of the deformation preventing member and into the engaging hole of the lower cover.

4. The backlight unit of claim 3, wherein
the lower cover further comprises a penetrating hole which extends through the bottom surface, and
the deformation preventing member further comprises a protrusion which protrudes from a lower portion of the mounting portion and into the penetrating hole of the lower cover.

5. The backlight unit of claim 1, further comprising an expansion preventing member at the remaining two second corners of the lower cover, wherein the expansion preventing member restricts expansion of the light guide plate such that the light guide plate does not contact the light source unit.

6. The backlight unit of claim 5, wherein the expansion preventing member comprises a non-elastic material.

7. The backlight unit of claim 6, wherein
the lower cover further comprises a bottom surface, a sidewall which extends from an edge of the bottom surface and an engaging hole which extends through the sidewall, and
the expansion preventing member comprises:
a mounting portion which overlaps a corner of the light guide plate;
sidewalls which extend from two sides of the mounting portion and contact the lower cover; and
a catching jaw which protrudes from at least one of the sidewalls of the expansion preventing member and into the engaging hole of the lower cover.

8. The backlight unit of claim 7, wherein
the lower cover further comprises a penetrating hole which extends through the bottom surface, and
the expansion preventing member further comprises a protrusion which protrudes from a lower portion of the mounting portion and into the penetrating hole of the lower cover.

9. The backlight unit of claim 7, wherein
the light guide plate further comprises a concave portion which recesses inward from second sides thereof adjacent to the first side, and
the expansion preventing member further comprises a protrusion which protrudes from the mounting portion and into the concave portion.

10. The backlight unit of claim 1, wherein
the light guide plate further comprises a concave portion which recesses inward from second sides thereof adjacent to the first side, and
the lower cover further comprises a bottom surface, lower cover side surfaces which extend upward from the bottom surface, and a protrusion which protrudes from the bottom surface into the concave portion.

11. The backlight unit of claim 10, wherein the concave portion is spaced apart from the light source unit by a distance equal to or smaller than about 1/10 of a distance between the first side of the light guide plate and a third side opposite to the first side.

12. A display apparatus comprising:
a backlight unit including a light source unit which generates and emits a light, and a light guide plate which guides the light;
a display panel which receives the light from the backlight unit and displays an image using the light;
a lower cover which accommodates the backlight unit and the display panel therein, and comprises four corners in a plan view; and
a deformation preventing member at two first corners among the four corners of the lower cover, which are spaced apart from the light source unit,
wherein
remaining two second corners of the four corners of the lower cover are adjacent to the light source unit, and
the deformation preventing member restricts deformation of the light guide plate.

13. The display apparatus of claim 12, wherein
the lower cover further comprises a bottom surface, a sidewall which extends from an edge of the bottom surface and an engaging hole which extends through the sidewall, and
the deformation preventing member comprises:
a mounting portion which overlaps a corner of the light guide plate;
sidewalls which extend from two sides of the mounting portion and contact with the lower cover; and
a catching jaw which protrudes from at least one of the sidewalls of the deformation preventing member and into the engaging hole of the lower cover.

14. The display apparatus of claim 13, wherein
the lower cover further comprises a penetrating hole which extends through the bottom surface, and
the deformation preventing member further comprises a protrusion which protrudes from a lower portion of the mounting portion and into the penetrating hole of the lower cover.

15. The display apparatus of claim 12, further comprising an expansion preventing member at the remaining two second corners of the lower cover, wherein the expansion preventing member restricts expansion of the light guide plate such that the light guide plate does not contact with the light source unit.

16. The display apparatus of claim 15, wherein
the lower cover further comprises a bottom surface, a sidewall which extends from an edge of the bottom surface and an engaging hole which extends through the sidewall, and
the expansion preventing member comprises:
a mounting portion which overlaps a corner of the light guide plate;
sidewalls which extend from two sides of the mounting portion and contact the lower cover; and
a catching jaw which protrudes from at least one of the sidewalls of the expansion preventing member and into the engaging hole of the lower cover.

17. The display apparatus of claim 16, wherein
the lower cover further comprises a penetrating hole which extends through the bottom surface, and
the expansion preventing member further comprises a protrusion which protrudes from a lower portion of the mounting portion and into the penetrating hole of the lower cover.

18. The display apparatus of claim 16, wherein
the light guide plate further comprises a concave portion which recesses inward from second sides thereof adjacent to the first side, and
the expansion preventing member further comprises a protrusion which protrudes from the mounting portion and into the concave portion.

19. The display apparatus of claim 12, wherein
the light guide plate further comprises a concave portion which recesses inward from second sides thereof adjacent to the first side, and
the lower cover further comprises a bottom surface, lower cover side surfaces which extend upward from the bottom surface, and a protrusion which protrudes from the bottom surface into the concave portion.

20. The display apparatus of claim 19, wherein the concave portion is spaced apart from the light source unit by a distance equal to or smaller than about 1/10 of a distance between the first side of the light guide plate and a third side opposite to the first side.
